(19) United States
(12) Patent Application Publication
(10) Pub. No.: US 2025/0383453 A1
(43) Pub. Date: Dec. 18, 2025

(54) GNSS COLD START USING REDUNDANT RECEIVERS

(71) Applicant: Nokia Solutions and Networks Oy, Espoo (FI)

(72) Inventors: Kin Yee Wong, Ottawa (CA); Aaron Helleman, Ottawa (CA)

(73) Assignee: Nokia Solutions and Networks Oy, Espoo (FI)

(21) Appl. No.: 18/746,194

(22) Filed: Jun. 18, 2024

(51) Int. Cl. G01S 19/27; G01S 19/06

(52) U.S. Cl. CPC G01S 19/27; G01S 19/06

(57) ABSTRACT

A stationary node (e.g., telecom router/switch) having at least two GNSS receivers. When the node is powered on, both GNSS receivers perform a startup sequence with the duration of the startup sequence for the second receiver being longer than that for the first receiver. When the first receiver finishes its startup sequence, a “fast-start” location is determined, and the first receiver switches to the normal operating mode using that fast-start location. When the second receiver finishes its longer startup sequence, a “slow-start” location is determined. Because its startup sequence duration is longer, the slow-start location should be more accurate than the fast-start location. As such, the first receiver transitions from operating in the normal mode using the fast-start location to operating in the normal mode using the slow-start location, thereby achieving both fast startup and accurate location determination.

### CROSS-REFERENCE TO RELATED APPLICATIONS

The subject matter of this application is related to U.S. patent application no. TBD filed on even date as attorney docket no. 331877-US-NP, the teachings of which are incorporated herein by reference in their entirety.

### BACKGROUND

### Field of the Disclosure

The present disclosure relates to global navigation satellite systems (GNSSs), such as the Global Positioning System (GPS) of the United States, the Galileo satellite positioning system of Europe, the BeiDou satellite navigation system of China, and the GLONASS satellite system of Russia, and, more specifically but not exclusively, to the cold start of nodes having stationary GNSS receivers.

### Description of the Related Art

This section introduces aspects that may help facilitate a better understanding of the disclosure. Accordingly, the statements of this section are to be read in this light and are not to be understood as admissions about what is prior art or what is not prior art.

It is known for certain nodes, such as routers and switches in telecommunication systems, to have a GNSS receiver that is used to determine the location (e.g., latitude, longitude, and altitude) of the node (technically, the location of the node's GNSS antenna) and, based on that determined location, determine a time/frequency reference for the node. It is also known to provision such a node with one or more additional GNSS receivers as backups in case of failure of the primary GNSS receiver.

For a stationary node like a telecom router or switch, when a GNSS receiver is initially powered on (i.e., a cold start), the receiver will perform a startup sequence for a period of time in order to determine the node's location. The receiver will then transition to a normal operating mode (aka position-hold mode) in which the determined location is used from then on to determine time/frequency for the node as long as the node remains powered.

In general, the longer the duration in which the GNSS receiver performs its startup sequence following a cold start, the more accurate will be the determination of the node's location and therefore the more accurate will be the determination of the node's time/frequency. There is, therefore, a trade-off in the prior art between the speed of a GNSS receiver's cold start and the accuracy of the resulting determination of the node's location. In addition, there may be some degree of random noise associated with the determination of location during the implementation of the startup sequence.

### SUMMARY

The present disclosure is directed to technology that addresses some of the issues described above. In certain embodiments, a node has at least first and second GNSS receivers. When the node is initially powered on, both GNSS receivers begin performing a startup sequence with the duration of the startup sequence for the second receiver being longer than that for the first receiver. When the first receiver finishes its startup sequence, a so-called “fast-start” location is determined, and the first receiver switches to the normal operating mode using that determined fast-start location.

When the second receiver later finishes its longer startup sequence, a so-called “slow-start” location is determined. It is assumed that, because the duration of the second receiver's startup sequence is longer than that for the first receiver, the slow-start location is more accurate than the fast-start location. As such, a transition is performed from operating the first receiver in the normal mode using the fast-start location to operating the first receiver in the normal mode using the slow-start location. Depending on the magnitude of the difference between the fast-start and slow-start locations, this transition may be a single jump from the fast-start location to the slow-start location (e.g., for small differences) or a more-gradual sequence of interpolated changes from the fast-start location to the slow-start location (e.g., for large differences).

In some implementations, the second receiver is restarted one or more times to determine one or more additional characterizations of the node's location that can be used to further refine the location used by the first receiver, thereby statistically accounting for at least some of the random noise associated with the determination of location during implementations of the startup sequence.

In other implementations, a single GNSS receiver is started and then restarted one or more times to determine multiple characterizations of the node's location that can be used to determine a more-accurate assessment of the location of the node.

### BRIEF DESCRIPTION OF THE DRAWINGS

Embodiments of the disclosure will become more fully apparent from the following detailed description, the appended claims, and the accompanying drawings in which like reference numerals identify similar or identical elements.

FIG. 1 is a simplified block diagram of a node, according to certain embodiments of the present disclosure;

FIG. 2 is a flow diagram of the processing implemented by the node of FIG. 1, according to certain embodiments of the present disclosure;

FIG. 3 is a flow diagram of the processing implemented by the node of FIG. 1, according to certain other embodiments of the present disclosure;

FIG. 4 is a simplified block diagram of a node, according to certain other embodiments of the present disclosure; and

FIG. 5 is a flow diagram of the processing implemented by the node of FIG. 4, according to certain embodiments of the present disclosure.

### DETAILED DESCRIPTION

Detailed illustrative embodiments of the present disclosure are disclosed herein. However, specific structural and functional details disclosed herein are merely representative for purposes of describing example embodiments of the present disclosure. The present disclosure may be embodied in many alternate forms and should not be construed as limited to only the embodiments set forth herein. Further, the terminology used herein is for the purpose of describing particular embodiments only and is not intended to be limiting of example embodiments of the disclosure.

As used herein, the singular forms “a,” “an,” and “the,” are intended to include the plural forms as well, unless the context clearly indicates otherwise. It further will be understood that the terms “comprises,” “comprising,” “contains,” “containing,” “includes,” and/or “including,” specify the presence of stated features, steps, or components, but do not preclude the presence or addition of one or more other features, steps, or components. It also should be noted that in some alternative implementations, the functions/acts noted may occur out of the order noted in the figures. For example, two figures shown in succession may in fact be executed substantially concurrently or may sometimes be executed in the reverse order, depending upon the functions/acts involved.

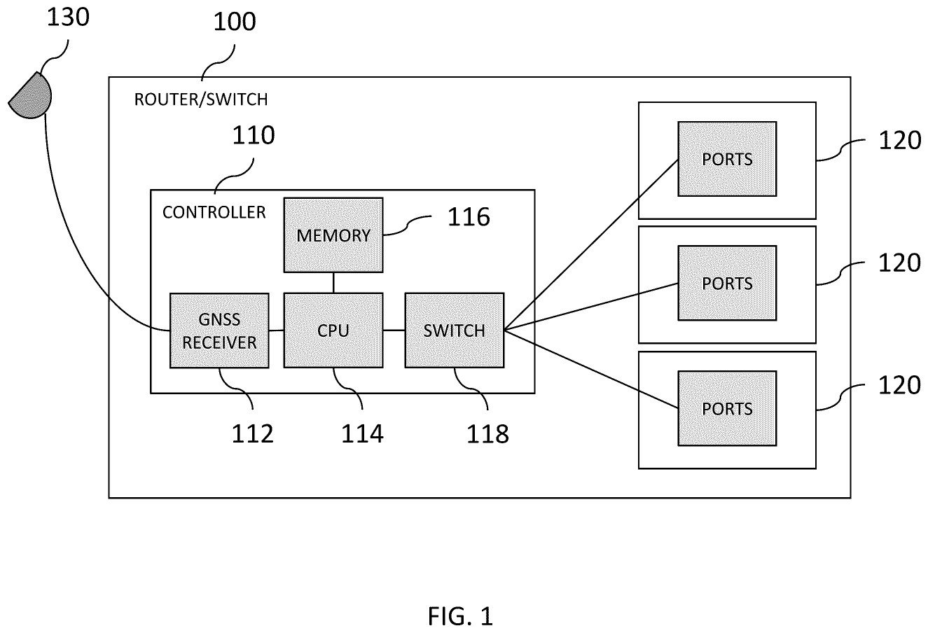

FIG. 1 is a simplified block diagram of a node 100 (e.g., a router or switch for a telecommunication system), according to certain embodiments of the present disclosure. To function as a telecom router or switch, node 100 has a control subsystem (aka controller) 110 and a number of line cards 120 that require accurate assessment of time and/or frequency to operate properly. To provide that accurate assessment, controller 110 has a GNSS receiver 112, a central processing unit (CPU) 114, non-volatile memory 116, and a switch 118.

In operation, the CPU 114 controls the GNSS receiver 112, which receives satellite signals captured by GNSS antenna 130. Following a cold start of node 100, CPU 114 configures receiver 112 to perform a startup sequence for a specified duration. At the end of that duration, the receiver 112 characterizes the node's location, which the CPU 114 stores in memory 116. The receiver 112 is then re-started one or more times to generate and store one or more additional characterizations of the node's location. The CPU 114 performs a statistical analysis on the multiple characterizations of the node's location to determine a final, calculated location of the node, which the receiver 112 then uses to determine time/frequency, which is distributed by the CPU 114 to the line cards 120 via switch 118.

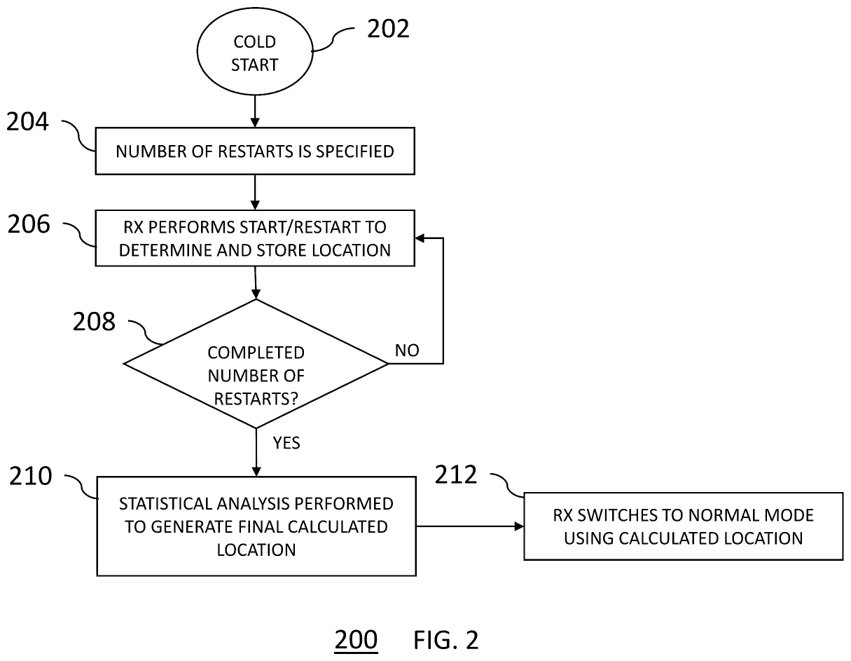

FIG. 2 is a flow diagram of the processing 200 implemented by the node 100 of FIG. 1, according to certain embodiments of the present disclosure. In this scenario, the receiver 112 is restarted a specified number of times.

In the scenario depicted in FIG. 2, the processing 200 begins, at step 202, with a cold start of node 100. In step 204, the number of restarts is specified, e.g., by the operator of node 100. In the first iteration of step 206, the receiver (RX) 112 performs its startup sequence to determine and store a first characterization of the node's location. In step 208, the CPU 114 determines whether the receiver 112 has already been restarted the specified number of times. If not, then processing returns to step 206 to restart the receiver's startup sequence to determine and store another characterization of the node's location. When the CPU 114 determines that the specified number of restarts has been reached, then processing continues to step 210.

In step 210, the CPU 114 performs a statistical analysis of the multiple characterizations of the node's location to generate a final, calculated location of the node 100. That statistical analysis may involve a weighted or unweighted average of the multiple, location characterizations or some other suitable statistical technique. In step 212, the receiver 112 is then switched to the normal operating mode using that final, calculated location to determine time/frequency.

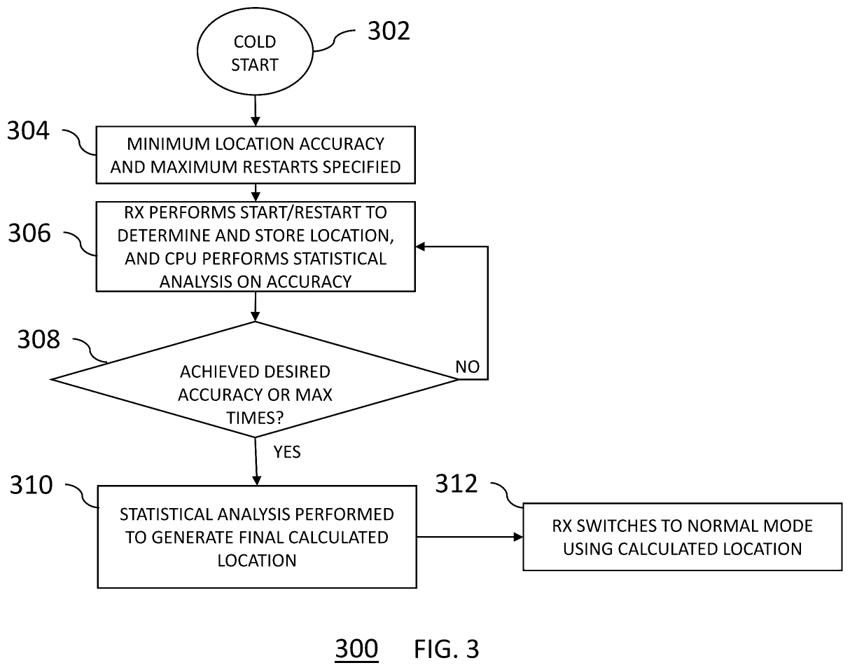

FIG. 3 is a flow diagram of the processing 300 implemented by the node 100 of FIG. 1, according to certain other embodiments of the present disclosure. In this scenario, the receiver 112 is restarted until either (i) a desired location accuracy is achieved or (ii) a specified, maximum number of restarts have been performed, whichever comes first.

In the scenario depicted in FIG. 3, the processing 300 begins, at step 302, with a cold start of node 100. In step 304, a minimum, desired location accuracy and a maximum number of restarts are specified, e.g., by the operator of node 100. In the first iteration of step 306, the receiver 112 performs its startup sequence to determine and store a first characterization of the node's location. In the first iteration of step 308, the CPU 114 determines that the desired location accuracy has not yet been met and processing returns to step 306 to restart the receiver's startup sequence to determine and store another characterization of the node's location. In addition, the CPU 114 performs a statistical analysis on the characterizations of the node's location generated so far to determine the accuracy of the characterizations, e.g., by calculating the variance of the set of location characterizations. In step 308, the CPU 114 determines (i) whether the calculated accuracy has reached the desired accuracy or (ii) whether the specified maximum number of restarts has been performed. If neither condition has been met, then the processing returns again to step 306. Otherwise, if either condition has been met, then processing continues to step 310.

In step 310, the CPU 114 performs a statistical analysis of the multiple characterizations of the node's location to generate a final, calculated location of the node 100, as in step 210 of FIG. 2. In step 312, the receiver 112 is then switched to the normal operating mode using that final, calculated location to determine time/frequency.

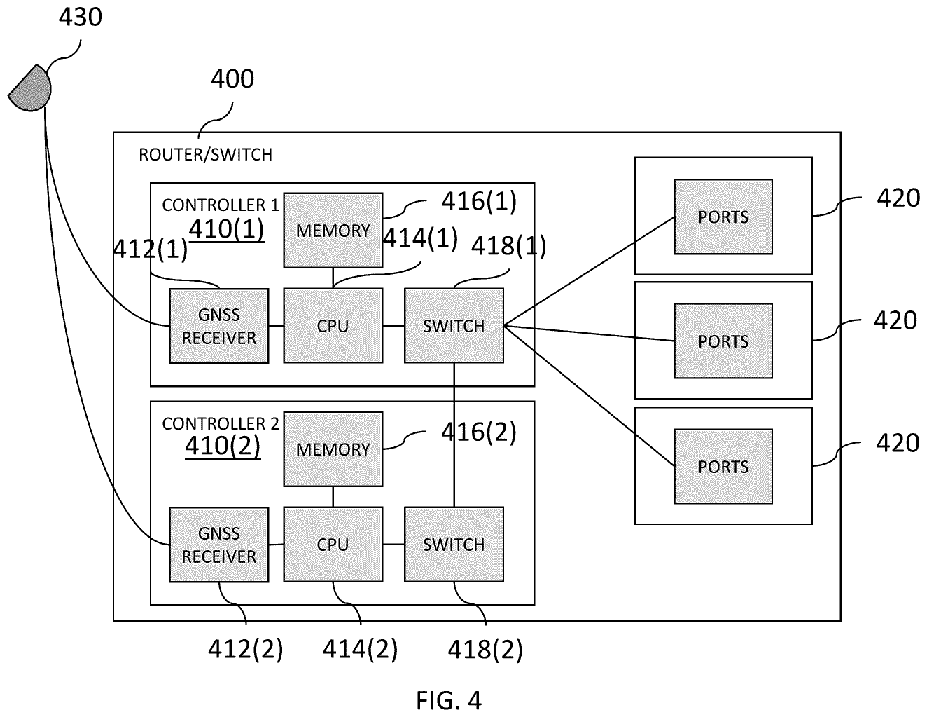

FIG. 4 is a simplified block diagram of a node 400 (e.g., a router or switch for a telecommunication system), according to certain embodiments of the present disclosure. Node 400 is analogous to node 100 of FIG. 1 with analogous elements having analogous labels, except that node 400 has two controllers 410(1) and 410(2). Note that both GNSS receivers 412(1) and 412(2) are connected to receive the same satellite signals from GNSS antenna AH. In addition, CPUs 414(1) and 414(2) can communicate with one another via switches 418(1) and 418(2) as well as distribute determined information to line cards 420.

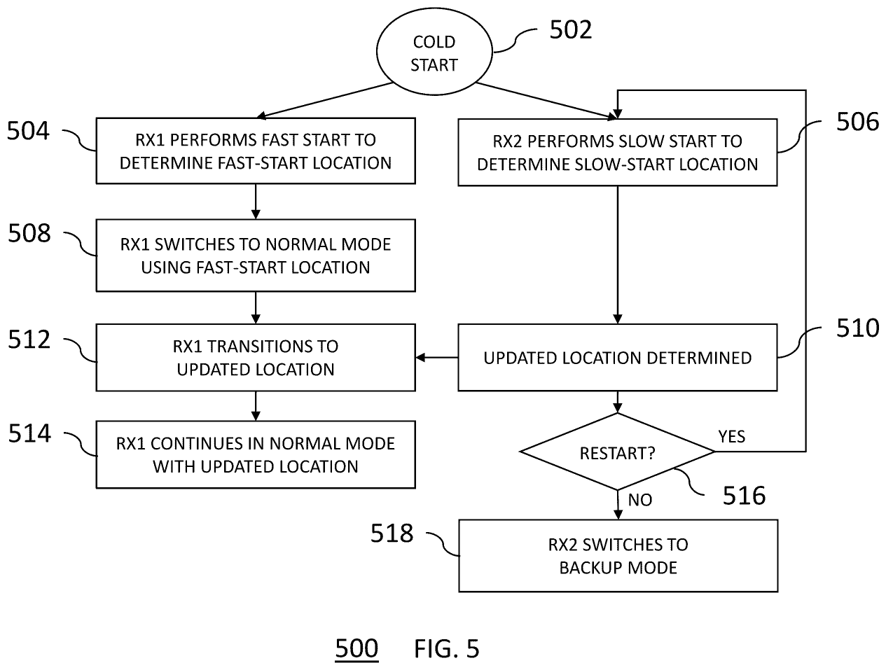

FIG. 5 is a flow diagram of the processing 500 implemented by node 400 of FIG. 4, according to certain embodiments of the present disclosure. In the scenario depicted in FIG. 5, the processing 500 begins, at step 502, with a cold start of node 400.

In that case, in parallel steps 504 and 506, the first and second GNSS receivers (R×1 and R×2) 412(1) and 412(2) both begin to perform startup sequences, but with different specified durations. In particular, in step 504, the first receiver 412(1) performs a startup sequence for a first duration (e.g., 30 minutes) to determine and store in memory 416(1) a first assessment of the location of the node 400 (referred to as the “fast-start” location), while, in step 506, the second receiver 412(2) performs a startup sequence for a longer, second duration (e.g., 4 hours) to determine and store in memory 416(2) Sa second assessment of the node's location (referred to as the “slow-start” location). Since the startup sequence of the second receiver 412(2) is longer than the startup sequence of the first receiver 412(1), the assumption is that the slow-start location determined by the second receiver 412(2) will be more accurate than the fast-start location determined by the first receiver 412(1).

Referring again to FIG. 5, after the first receiver 412(1) finishes its startup sequence of step 504, but while the second receiver 412(2) is still performing its startup sequence of step 506, in step 508, the first receiver 412(1) switches to its normal mode of operation with the fast-start location of step 504 being used to generate the time/frequency for the line cards AC of FIG. 4.

When the second receiver 412(2) eventually finishes its startup sequence of step 506, in step 510, the slow-start location determined during step 506 is used to determine an updated assessment of the node's location. In this initial iteration of the processing of step 510, the updated location may be set equal to the slow-start location from step 506. In some implementations, the updated location is determined by the second CPU 414(2) of the second controller 410(2) and transmitted to the first CPU 414(1) of the first controller 410(1) via the switches 418. In other implementations, the second CPU 414(2) transmits the slow-start location to the first CPU 414(1) via the switches 418, and the first CPU 414(1) determines the updated location.

In any case, in step 512, the first receiver 412(1) transitions from operating in its normal mode using its existing location (i.e., the fast location of step 504) to operating in its normal mode using the updated location of step 510. Depending on the implementation, that transition may involve a single hop from the existing location to the updated location (e.g., for relatively small differences between the two locations) or a more-gradual sequence of interpolated changes from the existing location to the updated location (e.g., for relatively large differences between the two locations).

In any case, after the transition of step 512 is completed, in step 514, the first receiver 412(1) continues to operate in its normal mode using the updated location to determine time/frequency for the line cards AC.

Note that the processing 500 so far has achieved a two-fold result: a relatively fast start-up of the first receiver 412(1), albeit with the relatively inaccurate, fast-start location, followed by continued operation of the first receiver 412(1) with the more-accurate, slow-start location, thereby achieving the dual goals of fast start-up and accurate long-term operation.

Referring again to FIG. 5, after the determination of the updated location of step 510, the option exists to restart the second receiver 412(2) one or more times. In some implementations, the number of restarts is a specified parameter. In other implementations, the decision whether to perform another restart of the second receiver 412(2) is dynamically determined based on the accuracy of the location determination, for example, based on the relative differences between consecutive assessments of location. Depending on the implementation, step 516 may be performed by the first CPU 414(1) or the second CPU 414(2).

If, in step 516, it is determined that another restart of the second receiver 412(2) is not needed, then, in step 518, the second receiver 412(2) switches to its backup mode to be available in case of failure of the first receiver 412(1).

If, however, it is determined in step 516 that another restart of the second receiver 412(2) is to be performed, then processing returns to step 506 to restart another instance of the second receiver 412(2) performing its startup sequence to determine another assessment of the node location. Note that, depending on the implementation, the duration of this additional startup sequence may be shorter, longer, or the same as the duration of the initial instance of step 506.

In any case, in step 510, the node location is updated based on at least the new assessment of the node location. In some implementations, such as when the duration of the additional startup sequence is significantly longer than the duration of the initial startup sequence, the update of step 510 may be based solely on the new location. In other implementations, such as when the duration of the additional startup sequence is the same as the duration of the initial startup sequence, the update of step 510 may be based on a direct average of the new location and original slow-start location. In still other implementations, the update of step 510 may be based on a weighted average of the new location and original slow-start location with the different weights determined based on such factors as the relative durations of the different startup sequences, the number of different satellite signals received during the different startup sequence, and/or the quality (e.g., signal-to-noise ratio) of those different satellite signals with greater weights given for longer durations, more satellites, and higher signal quality.

In any case, in a repeat of step 512, the first receiver 412(1) is again transitioned from operating in its normal mode using its existing location (i.e., the slow-start location from the first iteration of steps 506 and 510) to operating in its normal mode with the current, updated location from the recent iteration of steps 506 and 510.

Depending on the determination of step 516, the process of restarting the second receiver 412(2) may be iteratively repeated one or more times to continue to update and refine the assessment of the node's location (e.g., using weighted averages), thereby addressing random noise that might exist in the determination of location during any given instance of the startup sequence by averaging out that random noise using multiple assessments of location.

Those skilled in the art will understand that node 400 of FIG. 4 may be operated according to the processing 500 of FIG. 5 without restarting the second receiver 412(2). In that case, the first receiver 412(1) will quickly begin normal operations using the fast-start location of step 504 and then eventually transition to operating from then on using the more-accurate, slow-start location of step 506.

Those skilled in the art will also understand that a node having multiple receivers, such as node 400 of FIG. 4, may perform a single-receiver procedure, such as processing 200 of FIG. 2 or processing 300 of FIG. 3, in which only one receiver is started in its startup sequence to determine an initial assessment of location and then that same receiver is re-started one or more times to determine one or more additional assessments of location, all of which may be used to determine the location to be used by that receiver in its normal mode.

Those skilled in the art will also understand that a node may have more than two receivers with two or more backup receivers used to generate additional assessments of the node's location to update over time the location used by the node's primary receiver.

Although the present disclosure has been described in the context of stationary routers and switches for telecommunication systems, those skilled in the art will understand that the present disclosure can be implemented in the context of any suitable stationary nodes that use GNSS receivers to recover time, such as (without limitation) test equipment, electrical grid differential relays, computer systems used for high-speed trading/distributed computing for artificial intelligence.

In certain embodiments, the present disclosure is a method for a node having at least first and second global navigation satellite system (GNSS) receivers. The method comprises the first GNSS receiver performing a cold start for a first duration; the second GNSS receiver performing a cold start for a second duration longer than the first duration; the first GNSS receiver determining a fast-start location during its cold start; the first GNSS receiver transitioning to a normal operating mode using the fast-start location; the second GNSS receiver determining a slow-start location during its cold start; the node determining an updated location based on the slow-start location; and the first GNSS receiver continuing to operate in the normal operating mode based on the updated location.

In at least some of the above embodiments, the updated location is the slow-start location.

In at least some of the above embodiments, the node determines a sequence of updated locations based on the slow-start location; and the first GNSS receiver continues to operate in the normal mode based on the sequence of updated locations.

In at least some of the above embodiments, the second GNSS receiver is restarted for another duration; the second GNSS receiver determines a restart location during its restart; the node revises the updated location based on the restart location; and the first GNSS receiver continues to operate in the normal mode based on the revised, updated location.

In at least some of the above embodiments, the node generates the revised, updated location based on the slow-start location and the restart location.

In at least some of the above embodiments, the second GNSS receiver is restarted multiple times for multiple durations; the second GNSS receiver determines multiple restart locations during its multiple restarts; and the node uses the multiple restart locations to control operations of the first GNSS receiver in the normal mode.

In at least some of the above embodiments, the node comprises at least a third GNSS receiver; the third GNSS receiver performs a cold start for a third duration in parallel with the cold starts of the first and second GNSS receivers; the third GNSS receiver determines a third location during its cold start; and the node determines the updated location based on the slow-start location and the third location.

In at least some of the above embodiments, the third duration is longer than the second duration.

In at least some of the above embodiments, the third duration is the same as the second duration.

Unless explicitly stated otherwise, each numerical value and range should be interpreted as being approximate as if the word “about” or “approximately” preceded the value or range.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence. Likewise, additional steps may be included in such methods, and certain steps may be omitted or combined, in methods consistent with various embodiments of the disclosure.

Reference herein to “one embodiment” or “an embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments necessarily mutually exclusive of other embodiments. The same applies to the term “implementation.”

Unless otherwise specified herein, the use of the ordinal adjectives “first,” “second,” “third,” etc., to refer to an object of a plurality of like objects merely indicates that different instances of such like objects are being referred to, and is not intended to imply that the like objects so referred-to have to be in a corresponding order or sequence, either temporally, spatially, in ranking, or in any other manner.

Also, for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements. The same type of distinction applies to the use of terms “attached” and “directly attached,” as applied to a description of a physical structure.

As used herein in reference to an element and a standard, the terms “compatible” and “conform” mean that the element communicates with other elements in a manner wholly or partially specified by the standard and would be recognized by other elements as sufficiently capable of communicating with the other elements in the manner specified by the standard. A compatible or conforming element does not need to operate internally in a manner specified by the standard.

The described embodiments are to be considered in all respects as only illustrative and not restrictive. In particular, the scope of the disclosure is indicated by the appended claims rather than by the description and figures herein. All changes that come within the meaning and range of equivalency of the claims are to be embraced within their scope.

The functions of the various elements shown in the figures, including any functional blocks labeled as “processors” and/or “controllers,” may be provided through the use of dedicated hardware as well as hardware capable of executing software in association with appropriate software. Upon being provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

It should be appreciated by those of ordinary skill in the art that any block diagrams herein represent conceptual views of illustrative circuitry embodying the principles of the disclosure. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

As will be appreciated by one of ordinary skill in the art, the present disclosure may be embodied as an apparatus (including, for example, a system, a network, a machine, a device, a computer program product, and/or the like), as a method (including, for example, a business process, a computer-implemented process, and/or the like), or as any combination of the foregoing. Accordingly, embodiments of the present disclosure may take the form of an entirely software-based embodiment (including firmware, resident software, micro-code, and the like), an entirely hardware embodiment, or an embodiment combining software and hardware aspects that may generally be referred to herein as a “system” or “network”.

Embodiments of the disclosure can be manifest in the form of methods and apparatuses for practicing those methods. Embodiments of the disclosure can also be manifest in the form of program code embodied in tangible media, such as magnetic recording media, optical recording media, solid state memory, floppy diskettes, CD-ROMs, hard drives, or any other non-transitory machine-readable storage medium, wherein, upon the program code being loaded into and executed by a machine, such as a computer, the machine becomes an apparatus for practicing the disclosure. Embodiments of the disclosure can also be manifest in the form of program code, for example, stored in a non-transitory machine-readable storage medium including being loaded into and/or executed by a machine, wherein, upon the program code being loaded into and executed by a machine, such as a computer, the machine becomes an apparatus for practicing the disclosure. Upon being implemented on a general-purpose processor, the program code segments combine with the processor to provide a unique device that operates analogously to specific logic circuits. The term “non-transitory,” as used herein, is a limitation of the medium itself (i.e., tangible, not a signal) as opposed to a limitation on data storage persistency (e.g., RAM vs. ROM).

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements. For example, the phrases “at least one of A and B” and “at least one of A or B” are both to be interpreted to have the same meaning, encompassing the following three possibilities: 1-only A; 2-only B; 3-both A and B.

All documents mentioned herein are hereby incorporated by reference in their entirety or alternatively to provide the disclosure for which they were specifically relied upon.

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

As used herein and in the claims, the term “provide” with respect to an apparatus or with respect to a system, device, or component encompasses designing or fabricating the apparatus, system, device, or component; causing the apparatus, system, device, or component to be designed or fabricated; and/or obtaining the apparatus, system, device, or component by purchase, lease, rental, or other contractual arrangement.

While preferred embodiments of the disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the technology of the disclosure. It is intended that the following claims define the scope of the invention and that methods and structures within the scope of these claims and their equivalents be covered thereby.

What is claimed is:

1. A method for a node having at least first and second global navigation satellite system (GNSS) receivers, the method comprising:
the first GNSS receiver performing a cold start for a first duration;
the second GNSS receiver performing a cold start for a second duration longer than the first duration;
the first GNSS receiver determining a fast-start location during its cold start;
the first GNSS receiver transitioning to a normal operating mode using the fast-start location;
the second GNSS receiver determining a slow-start location during its cold start;
the node determining an updated location based on the slow-start location; and
the first GNSS receiver continuing to operate in the normal operating mode based on the updated location.

2. The method of claim 1, wherein the updated location is the slow-start location.

3. The method of claim 1, wherein:
the node determines a sequence of updated locations based on the slow-start location; and
the first GNSS receiver continues to operate in the normal mode based on the sequence of updated locations.

4. The method of claim 1, wherein:
the second GNSS receiver is restarted for another duration;
the second GNSS receiver determines a restart location during its restart;
the node revises the updated location based on the restart location; and
the first GNSS receiver continues to operate in the normal mode based on the revised, updated location.

5. The method of claim 4, wherein the node generates the revised, updated location based on the slow-start location and the restart location.

6. The method of claim 1, wherein:
the second GNSS receiver is restarted multiple times for multiple durations;
the second GNSS receiver determines multiple restart locations during its multiple restarts; and
the node uses the multiple restart locations to control operations of the first GNSS receiver in the normal mode.

7. The method of claim 1, wherein:
the node comprises at least a third GNSS receiver;
the third GNSS receiver performs a cold start for a third duration in parallel with the cold starts of the first and second GNSS receivers;
the third GNSS receiver determines a third location during its cold start; and
the node determines the updated location based on the slow-start location and the third location.

8. The method of claim 7, wherein the third duration is longer than the second duration.

9. The method of claim 7, wherein the third duration is the same as the second duration.

10. A node comprising:
at least first and second GNSS receivers;
at least one processor; and
at least one memory storing instructions that, upon being executed by the at least one processor, cause at least:
the first GNSS receiver to perform a cold start for a first duration;
the second GNSS receiver to perform a cold start for a second duration longer than the first duration;
the first GNSS receiver to determine a fast-start location during its cold start;
the first GNSS receiver to transition to a normal operating mode using the fast-start location;
the second GNSS receiver to determine a slow-start location during its cold start;
the node to determine an updated location based on the slow-start location; and
the first GNSS receiver to continue to operate in the normal operating mode based on the updated location.

11. The node of claim 10, wherein the updated location is the slow-start location.

12. The node of claim 10, wherein:
the node is adapted to determine a sequence of updated locations based on the slow-start location; and
the first GNSS receiver is adapted to continue to operate in the normal mode based on the sequence of updated locations.

13. The node of claim 10, wherein:
the second GNSS receiver is adapted to be restarted for another duration;
the second GNSS receiver is adapted to determine a restart location during its restart;
the node is adapted to revise the updated location based on the restart location; and
the first GNSS receiver is adapted to continue to operate in the normal mode based on the revised, updated location.

14. The node of claim 13, wherein the node is adapted to generate the revised, updated location based on the slow-start location and the restart location.

15. The node of claim 10, wherein:
the second GNSS receiver is adapted to be restarted multiple times for multiple durations;
the second GNSS receiver is adapted to determine multiple restart locations during its multiple restarts; and
the node is adapted to use the multiple restart locations to control operations of the first GNSS receiver in the normal mode.

16. The node of claim 10, wherein:
the node comprises at least a third GNSS receiver;
the third GNSS receiver is adapted to perform a cold start for a third duration in parallel with the cold starts of the first and second GNSS receivers;
the third GNSS receiver is adapted to determine a third location during its cold start; and
the node is adapted to determine the updated location based on the slow-start location and the third location.

17. The node of claim 16, wherein the third duration is longer than the second duration.

18. The node of claim 16, wherein the third duration is the same as the second duration.
